(19) United States
(12) Patent Application Publication
(10) Pub. No.: US 2007/0283429 A1
(43) Pub. Date: Dec. 6, 2007

(54) Sequence number based TCP session proxy

(75) Inventors: Lee Chen, Saratoga, CA (US); Ronald Wai Lun Szeto, Pleasanton, CA (US); Shih-Tsung Hwang, San Jose, CA (US)

Correspondence Address: KAPLAN GILMAN GIBSON & DERNIER L.L.P., 900 ROUTE 9 NORTH, WOODBRIDGE, NJ, 07095, US

(73) Assignee: A10 Networks Inc., San Jose, CA (US)

(21) Appl. No.: 11/442,774

(22) Filed: May 30, 2006

(51) Int. Cl. G06F 15/16

(52) U.S. Cl. 726/11

(57) ABSTRACT

In a computer communication network including a firewall which protects a secured host against attack from outside computers, the host communicating with an outside computer, through the firewall, via data packets which include byte sequence numbers. In a communication between the host and computer in which one of them acts as a source and the other as a destination for the communication, a sequence number offset is derived by the firewall which characterizes the byte sequence number received from the source and the byte sequence number the firewall will provide to the destination for that communication. In a communication received from the source, the firewall adds the offset to byte sequence numbers in a packet passing between the source and destination, in order to determine the byte sequence numbers it will provide to the destination. Thus, proper sequence numbers can be provided to both locations, without the firewall having to restructure packets. This speeds communication between the source and destination and substantially reduces the commitment of processing and storage resources.

### BACKGROUND OF THE INVENTION

This invention relates generally to telecommunications, and more specifically, to a method to mediate TCP session between two host computers useful in avoiding denial of service attacks.

Transmission Control Protocol (TCP) is a transport protocol in the Internet protocol (IP) suite. A source host uses a TCP three-way handshake to establish a connection with a destination host, and exchanges data packets over the connection. More specifically, the three-way handshake that is used to establish a TCP session involves the following: a TCP coordinating request (SYN) packet is sent from a client to a server; the server returns a coordinating request plus response (SYN+ACK) packet; and the client sends a response (ACK) packet.

TCP supports many application layer protocols, such as Hypertext Transfer Protocol (HTTP), File Transfer Protocol (FTP), Simple Mail Transfer Protocol (SMTP), Post Office Protocol Version 3 (POP3), Internet Message Access Protocol (IMAP), Session Initiation Protocol (SIP), Secure Shell (SSH) protocol and TELNET protocol. These application protocols encompass the major communication services such as e-mail services, file transfer services, voice over IP (VoIP) services, and web browsing services that are provided over a packet data network, such as the Internet, or a corporate Virtual Private Network (VPN).

A TCP SYN flood attack is a well known denial of service attack that exploits the TCP three-way handshake design by having an attacking source host generate TCP SYN packets with random source addresses toward a victim destination host. The victim destination host sends a SYN+ACK back to the random source address, adds an entry to its connection queue, and allocates host resources. Since the SYN+ACK is destined for an incorrect or non-existent source host, the last part of the “three-way handshake” is never completed and the entry remains in the connection queue until a timer expires, typically for about one minute. By generating false TCP SYN packets from random IP addresses at a rapid rate, it is possible to fill up the connection queue and deny TCP services (such as e-mail, file transfer, or web browsing) to legitimate source hosts.

Newer operating systems or platforms implement various solutions to minimize the impact of security risk such as TCP SYN flood attacks. These solutions include better methods to validate a source host, and better resource management. Validation includes techniques such as TCP SYN Cookie, or high level authentication of the user of a source host.

Existing implementations are typically done by having a computing device, such as a firewall, a router or a border gateway handle the SYN and ACK packets during the TCP “three-way handshake” process, while determining the validity of the source host. After establishing a first TCP session with the source host, the computing device will establish a second TCP session with the intended destination host.

A typical implementation, oftentimes called a TCP proxy, includes allocating buffers of the proper sizes; and mediating data communication between the first and second TCP sessions during their lifetimes. This implementation requires extensive memory and computing resources in order to conduct tasks such as TCP header and IP header manipulation, sliding window management, packet retransmission, and IP packet fragmentation and reassembling. This makes it difficult for the computing device to handle a high volume of simultaneous TCP sessions.

Therefore, there is a need for a system and method for handling a high volume of simultaneous TCP sessions with source hosts and destination hosts for security applications.

### SUMMARY OF THE INVENTION

The present invention is used in a computer communication network including a firewall which protects a secured host against attack from outside computers. The host communicates with an outside computer, through the firewall, via data packets which include byte sequence numbers. In accordance with one aspect of the invention, in a communication between the host and computer in which one of them acts as a source and the other as a destination for the communication, a sequence number offset is derived by the firewall which characterizes the byte sequence number received from the source and the byte sequence number the firewall will provide to the destination for that communication. In a communication received from the source, the firewall adds the offset to byte sequence numbers in a packet passing between the source and destination, in order to determine the byte sequence numbers it will provide to the destination. Thus, proper sequence numbers can be provided to both locations, without the firewall having to restructure packets. This speeds communication between the source and destination and substantially reduces the commitment of processing and storage resources.

### BRIEF DESCRIPTION OF DRAWINGS

The foregoing brief description and further objects, features and advantages will be understood more completely from the following description of the presently preferred, but nonetheless illustrative, embodiments with reference being had to the accompanying drawings in which:

FIG. 1 is a block diagram showing the general configuration of a secure network including a firewall to link together two hosts;

FIG. 2 is a block diagram representation of a firewall embodying the present invention;

FIG. 3 illustrates the preferred structure for a session entry in accordance with the present invention;

FIG. 4 is a block diagram illustrating a process for configuring a session entry and a Lookup Module 270 of FIG. 2;

FIG. 5 is a block diagram illustrating a preferred process performed by a Packet Composer 250 and processing an IP packet;

FIG. 6 is a block diagram illustrating a preferred firewall in accordance with the invention, the firewall having multiple operating packet composers; and

FIG. 7 is a flowchart illustrating a process for computing output sequence number from input sequence number.

### DETAILED DESCRIPTION OF THE PREFERRED EMBODIMENT

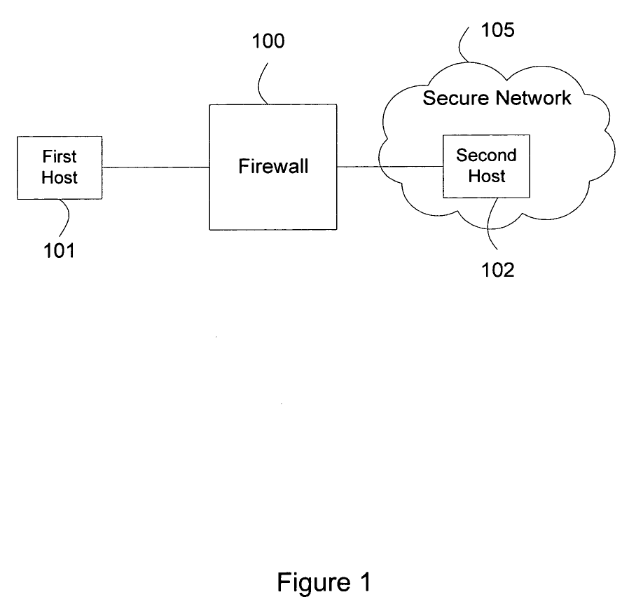

FIG. 1 is a block diagram representation of a secure network 105 with a firewall 100, a first host 101 and a second host 102. First host 101 establishes a TCP session with second host 102. The TCP session traffic goes through firewall 100. First host 101 is outside secure network 105; second host 102 is inside secure network 105.

When first host 101 sends a TCP SYN segment to establish a TCP session with a second host 102, firewall 100 receives the TCP SYN segment. Firewall 100 establishes a TCP session with first host 101. Then firewall 100 establishes a TCP session with second host 102. After the two TCP sessions are established, firewall 100 relays IP packets over the TCP session with first host 101 to the TCP session with second host 102 and vice versa.

In one embodiment, first host 101 connects to firewall 100 over a communication network. Preferably, the communication network includes the Internet, a corporate virtual private network or VPN, or a wireless network, such as a General Packet Radio Service (GPRS) network or a WiFi network.

Preferably, second host 102 provides a Web service, which may be an Email service, a file transfer protocol (FTP) service, a Voice over IP (VoIP) service, an Instant Messenger (IM) service, a media streaming service, or a content distribution service such as a music download service or a movie download service.

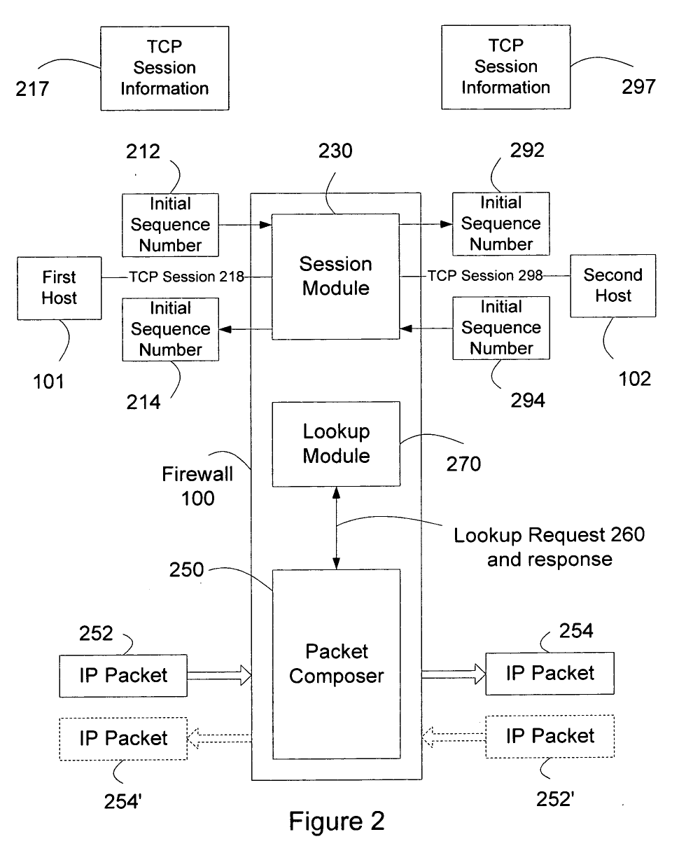

As best seen in the block diagram of FIG. 2, firewall 100 includes a session module 230, a lookup module 270, and a packet composer 250. Session module 230 establishes a TCP session 218 with first host 101. During the establishment of TCP session 218, session module 230 receives an initial sequence number 212 from first host 101 and sends initial sequence number 214 (arbitrary) to first host 101. In these communications, each byte of data has an associated sequence number. Under the protocol, a communicating device will assign an arbitrary sequence number to the first byte and will increment it by 1 for each successive byte.

Session module 230 obtains TCP session information 217 from TCP session 218. Preferably, session module 230 obtains first TCP session information 217 from the TCP SYN segment received from first host 101. Preferably, first TCP session information 217 includes source address and destination address fields in the IP header of the TCP SYN segment and source port and destination port fields in the TCP header of the TCP SYN segment.

Session module 230 establishes a TCP session 298 with second host 102 based on first TCP session information 217. Preferably, session module 230 composes a TCP SYN segment. Session module 230 stores in the TCP SYN segment the fields of source address, source port, destination address and destination port from the corresponding fields in TCP session information 217. Firewall 100 sends the TCP SYN segment to establish TCP session 298.

During the establishment of TCP session 298, session module 230 sends initial sequence number 292 (arbitrary) to second host 102, and receives initial sequence number 294 (arbitrary) from second host 102. Session module 230 obtains second TCP session information 297 from a TCP segment, such as the TCP SYN+ACK segment during the TCP session establishment segments exchange, from second host 102. Second TCP session information 297 includes source address and destination address fields in the IP header of the TCP SYN+ACK segment and source port and destination port fields in the TCP header of the TCP SYN+ACK segment.

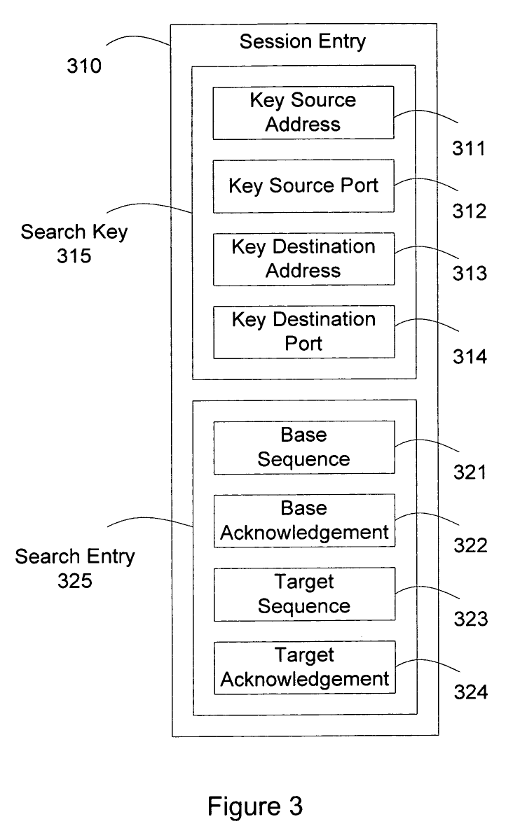

Lookup module 270 includes the functionality of configuring a session entry based on TCP session information 217 and TCP session information 297. The format of a session entry is illustrated schematically in block form in FIG. 3. Lookup module 270 includes the functionality of processing a lookup request, retrieving a session entry based on lookup request, and responding to the lookup request based on the retrieved session entry. Look up module 270 is discussed in more detail below.

When firewall 100 receives an IP packet 252, packet composer 250 generates an IP packet 254 based on IP packet 252. Preferably, packet composer 250 sends to lookup module 270 a lookup request 260 based on IP packet 252. Packet composer 250 modifies IP packet 254 based on the response from lookup module 270.

Firewall 100 sends IP packet 254. Preferably, firewall 100 receives IP packet 252 from first host 101 and sends IP packet 254 to second host 102. Likewise, firewall 100 may receive IP packet 252′ from second host 102 and send IP packet 254′ to first host 101.

FIG. 3 illustrates a session entry in block diagram form. A session entry 310 includes a search key 315 and a search entry 325. Search key 315 includes as key components key source address 311, key source port 312, key destination address 313, and key destination port 314. Search entry 325 includes as data components base sequence 321, base acknowledgement 322, target sequence 323 and target acknowledgement 324. A session entry is created and then updated for each session. The search key is unique to each session and makes it possible to locate the corresponding session entry, permitting it to be updated as more data is received.

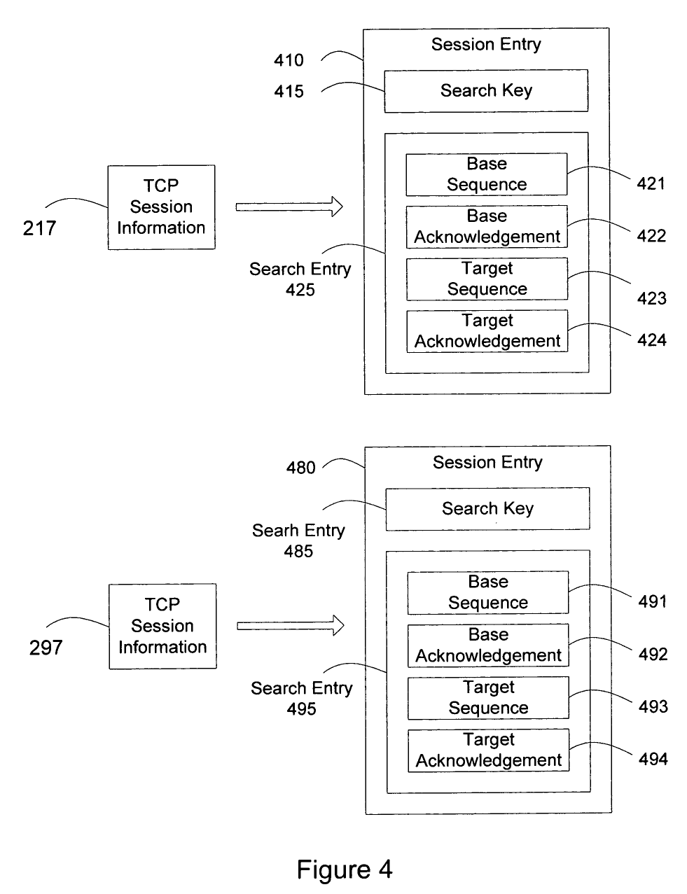

FIG. 4 illustrates, in block form, a process performed by Lookup Module 270 to configure a session entry. Lookup module 270 sets a first session entry 410 which includes first search key 415 and first search entry 425. Lookup module 270 sets a second session entry 480 which includes second search key 485 and second search entry 495. Lookup module 270 sets first search key 415 based on first TCP session information 217. Specifically, the fields of first search key 415 are set from the corresponding fields of the first TCP session information 217. In first search entry 425, base sequence 421 is set to equal initial sequence number 212; base acknowledgement 422 is set equal to initial sequence number 214; target sequence 423 is set equal to initial sequence number 292; and target acknowledgement 424 is set equal to initial sequence number 294.

Lookup module 270 sets second search key 485 based on second TCP session information 297, setting the fields of second search key 485 from the corresponding fields of the second TCP session information 297. The second search entry 495 is created by setting: base sequence 491 to equal initial sequence number 294; base acknowledgement 492 to equal initial sequence number 292; target sequence 493 to equal initial sequence number 214; and target acknowledgement 494 to equal initial sequence number 212.

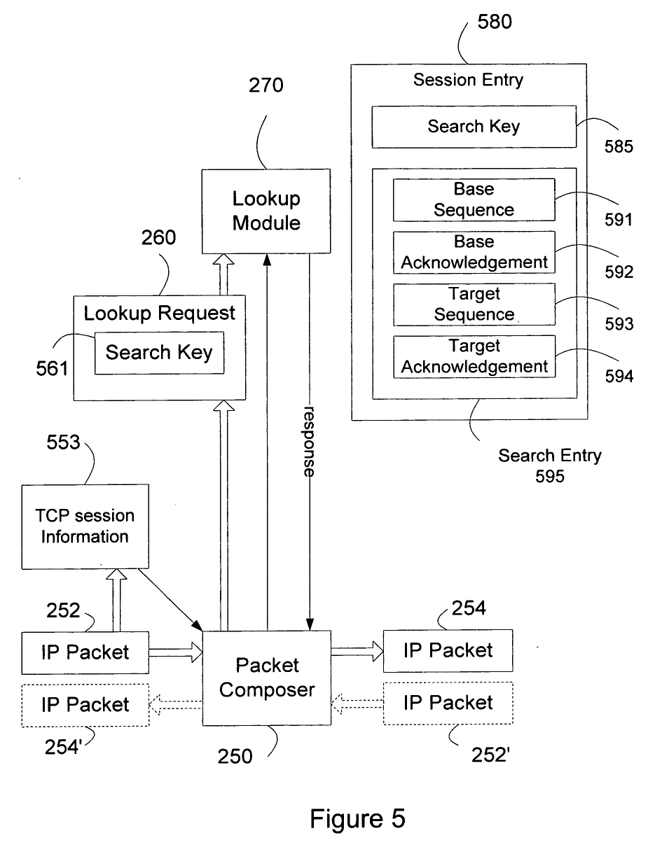

FIG. 5 illustrates, in block diagram form, a process for Packet Composer 250 to process an IP packet.

Firewall 100 receives an IP packet 252 from first host 101 (or an IP packet 252′ from second host 102). The second situation will be represented in parentheses and illustrated in phantom in FIG. 5. Packet composer 250 generates an IP packet 254 (254′). First, packet composer sets IP packet 254 (254′) to equal IP packet 252 (252′). Preferably, the Fragment Offset in IP packet 252 (252′) has a value of “0” and IP packet 252 (252′) includes a complete TCP Header. Packet composer 250 composes a lookup request 260, which includes a search key 561. Packet composer 250 obtains TCP session information 553 from IP packet 252 (252′), which includes source address and destination address fields in the IP header of IP packet 252 (252′); and source port and destination port fields in the TCP header of IP packet 252 (252′). Packet composer 250 sets the fields of search key 561 from the corresponding fields of TCP session information 553, and it sends lookup request 260 to lookup module 270. As mentioned previously, this combination of information defines a unique session, permitting the respective session entry to be recovered (and processed).

Lookup module 270 processes lookup request 260. Lookup module 270 retrieves a session entry 580 whose search key 585 matches search key 561. Preferably, lookup module 270 determines that search key 585 matches search key 561 by determining that the fields of the search key 581 match the corresponding fields of search key 561.

Lookup module 270 responds to lookup request 260 by sending to packet composer 250 data components of search entry 595 of the matched session entry 580. The data components in search entry 595 include base sequence 591, base acknowledgement 592, target sequence 593, and target acknowledgement 594.

Much of the processing load and memory allocation is dedicated creating data communications between the two sessions, including such tasks as various header manipulations and IP packet fragmentation and reassembling. In accordance with an aspect of the present invention, packet processing is substantially improved, as is memory utilization, by computing a sequence number offset when a session is first initiated. The offset is then added to an incoming sequence number in order to arrive at the outgoing sequence number.

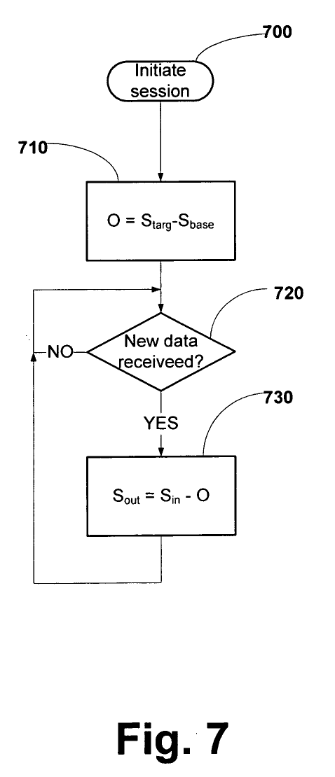

FIG. 7 is a flowchart illustrating a preferred process for doing this. A session is initiated at block 700. At block 710, an Offset is calculated in accordance with the following equation:

O=S_{targ}−S_{base}

where O is the offset, S_{targ} is the initial target sequence number (the data destination's initial byte number), and S_{base} is the initial base sequence number (the data source's initial byte number).

Thereafter, whenever new date is received, as represented by block 720, the byte sequence number of the outgoing data Sₒᵤₜ is computed in accordance with the following equation:

Sₒ₊ᵤₜ=Sᵢₙ+O

where Sᵢₙ is the sequence number of the incoming data and O is the offset (may be a negative number) previously determined.

Turning now to a specific example of how the method is achieved by continuing the previous example, packet composer 250 sets the sequence number and acknowledgement number in IP packet 254 based on IP packet 252 and the response from lookup module 270. Packet composer 250 calculates sequence number of IP packet 254 by subtracting base sequence 591 from the sequence number in IP packet 252, and by adding the result of the subtraction to target sequence 593. In other words, the offset is equal to the difference between target sequence 593 and base sequence 591. First packet composer 250 calculates a first 32-bit data element, such that the result of an unsigned binary addition of the first 32-bit data element and base sequence 591 equals the sequence number in IP packet 252. For example, base sequence 591 may be a hexadecimal “70796BEF” and the sequence number in IP packet 252 may be “E39B5022”. The first 32-bit data element is calculated to “7321E433”. As another example, base sequence 591 may be “813D02FB” and the sequence number in IP packet 252 may be “049A8B23”. The first 32-bit data element is the calculated to “835D8828”.

Similarly, packet composer 250 calculates a second 32-bit data element by performing an unsigned binary addition of the first 32-bit data element and target sequence 593. For example, the first 32-bit data element may be “7321E433” and target sequence 593 may be “000024BE”. The second 32-bit date element is then calculated to “732208F1”. As another example, the first 32-bit data element may be “7321E433” and target sequence 593 may be “FE052413”. The second 32-bit element is calculated to “71270846”. Packet composer 250 stores the second 32-bit data element in the sequence number field of IP packet 254.

Packet composer 250 calculates the acknowledgement number field of IP packet 254 by subtracting base acknowledgement 592 from the acknowledgement number in IP packet 252; and by adding the result of the subtraction to target acknowledgement 594. Packet composer 250 calculates a third 32-bit data element, such that the result of an unsigned binary addition of the third 32-bit data element and base acknowledgement 592 equals the acknowledgement number in IP packet 252. Packet composer 250 calculates a fourth 32-bit data element by performing an unsigned binary addition of the third 32-bit data element and target acknowledgement 594. Packet composer 250 stores the fourth 32-bit data element in the acknowledgement number field of IP packet 254.

Packet composer 250 calculates the checksum for IP packet 254. Preferably, packet composer 250 computes the checksum based on section 3.3 of “Header Manipulations” in IETF RFC 1631 “The IP Network Address Translator (NAT)”.

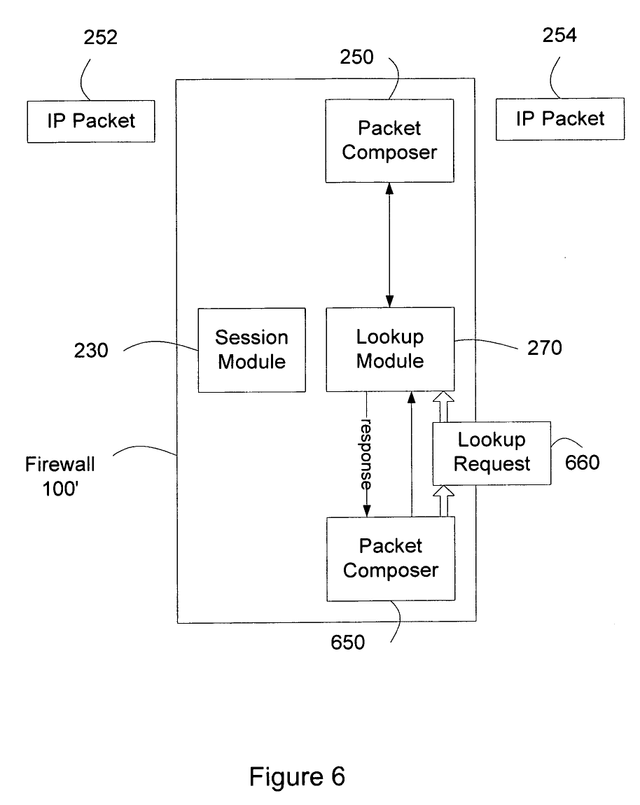

FIG. 6 illustrates a firewall with multiple packet composers. Preferably, firewall 100′ includes session module 230, lookup module 270, and packet composers 250 and 650. Packet composer 250 may be in an active mode and packet composer 650 is in a standby mode. In the active mode, packet composer 250 processes an IP packet 252 received by firewall 100′ and generates an IP packet 254 as illustrated in FIG. 5. When packet composer 250 malfunctions, packet composer 650 becomes active and processes an IP packet 252 received by firewall 100 and generates an IP packet 254. Packet composer 650 may send to lookup module 270 a lookup request 660 based on IP packet 652, and modify IP packet 654 based on the response from lookup module 270. Alternatively, packet composer 250 and packet composer 650 may be in a load-balancing arrangement in which both packet composer 250 and packet composer 650 are in the active mode.

Preferably, a search key includes an additional component. The additional component may be: an Ethernet VLAN identity; a Multi-Protocol Label Switching (MPLS) label; as label is described in IETF RFC 3031 “Multiprotocol Label Switching Architecture”; a tunnel identity; a tunnel which is a Layer Two Tunnel Protocol (L2TP) tunnel, a Generic Routing Encapsulation (GRE) tunnel, or an Internet Protocol Security (IPSec) tunnel. L2TP tunnel is described in IETF RFC 2661 “Layer Two Tunneling Protocol L2TP”. GRE tunnel is described in IETF RFC 2784 “Generic Routing Encapsulation (GRE)”. IPSec tunnel is described in IETF RFC 2402 “IP Authentication Header”.

A hardware-based computing module may embody a packet composer; may be a Field Programmable Gate Array (FPGA); or may be an Application Specific Integrated Circuit (ASIC). The hardware-based computing module may include a network processor.

A Lookup Module may use other matching algorithms, such as hashing algorithms, or it may connect to a lookup memory such as Content Addressable Memory (CAM) or a Ternary Content Addressable Memory (TCAM). The lookup memory stores a plurality of search keys. Lookup memory checks if the search key in a lookup request matches one or more of the plurality of search keys.

The firewall 100 may be an access gateway; a border gateway; a network access point, such as a wireless access point; a Remote Access Server (RAS) or a Broadband Remote Access Server (BRAS); a session border controller; an application level gateway, such as a Hypertext Transfer Protocol (HTTP) proxy, or a Session Initiation Protocol (SIP) proxy; or a broadband gateway.

Although preferred embodiments of the invention have been disclosed for illustrative purposes, those skilled in the art will appreciate that many additions, modifications, and substitutions are possible without departing from the scope and spirit of the invention as defined by the accompanying claims.

What is claimed:

1. In a computer communication network including a firewall protecting a secured host against attack from outside computers, the host and an outside computer communicating through the firewall via data packets including byte sequence numbers, a method for processing communications between the host and computer, one of which acts as a source and the other as a destination for the communication, said method comprising the steps of:
defining a sequence number offset which characterizes the byte sequence number received by the firewall from the source and the byte sequence number the firewall will provide to the destination for that communication; and
in the firewall, combining the offset with a source byte sequence number in a packet the firewall receives from the source to determine a corresponding destination byte sequence number the firewall will provide to the destination in place of the source byte sequence number.

2. The method of claim 1 wherein the offset is a combination of an initial byte sequence number that the firewall provides to the destination and an initial byte sequence number that the source provides to the firewall.

3. The method of claim 2 wherein the combination is a subtraction.

4. The method of claim 3 wherein the combining step is an addition.

5. The method of claim 1 wherein the combining step is an addition.

6. The method of claim 5 further comprising performing an additional combining step with a different source byte sequence number than that in the combining step.

7. The method of claim 6 wherein the combining step is performed apart from the additional combining step and the additional combining step is one of: a substitute for the combining step; and performed simultaneously with the combining step.

8. The method of claim 5 further comprising the additional steps of:
defining a second offset which characterizes: a byte sequence number received by the firewall from the destination in a reverse communication; and the byte sequence number the firewall will provide to the source for the reverse communication; and
in the firewall, combining the second offset with a byte sequence number in a packet the firewall receives from the destination to determine a corresponding byte sequence number the firewall will provide to the source in place of the destination byte sequence number.

9. The method of claim 4 further comprising performing an additional combining step with a different source byte sequence number than that in the combining step.

10. The method of claim 9 wherein the combining step is performed apart from the additional combining step and the additional combining step is one of: a substitute for the combining step; and performed simultaneously with the combining step.

11. The method of claim 4 further comprising the additional steps of:
defining a second offset which characterizes: a byte sequence number received by the firewall from the destination in a reverse communication; and the byte sequence number the firewall will provide to the source for the reverse communication; and
in the firewall, combining the second offset with a byte sequence number in a packet the firewall receives from the destination to determine a corresponding byte sequence number the firewall will provide to the source in place of the destination byte sequence number.

12. The method of claim 3 further comprising performing an additional combining step with a different source byte sequence number than that in the combining step.

13. The method of claim 12 wherein the combining step is performed apart from the additional combining step and the additional combining step is one of: a substitute for the combining step; and performed simultaneously with the combining step.

14. The method of claim 3 further comprising the additional steps of:
defining a second offset which characterizes: a byte sequence number received by the firewall from the destination in a reverse communication; and the byte sequence number the firewall will provide to the source for the reverse communication; and
in the firewall, combining the second offset with a byte sequence number in a packet the firewall receives from the destination to determine a corresponding byte sequence number the firewall will provide to the source in place of the destination byte sequence number.

15. The method of claim 2 further comprising performing an additional combining step with a different source byte sequence number than that in the combining step.

16. The method of claim 15 wherein the combining step is performed apart from the additional combining step and the additional combining step is one of: a substitute for the combining step; and performed simultaneously with the combining step.

17. The method of claim 2 further comprising the additional steps of:
defining a second offset which characterizes: a byte sequence number received by the firewall from the destination in a reverse communication; and the byte sequence number the firewall will provide to the source for the reverse communication; and
in the firewall, combining the second offset with a byte sequence number in a packet the firewall receives from the destination to determine a corresponding byte sequence number the firewall will provide to the source in place of the destination byte sequence number.

18. The method of claim 1 further comprising performing an additional combining step with a different source byte sequence number than that in the combining step.

19. The method of claim 18 wherein the combining step is performed apart from the additional combining step and the additional combining step is one of: a substitute for the combining step; and performed simultaneously with the combining step.

20. The method of claim 1 further comprising the additional steps of:
defining a second offset which characterizes: a byte sequence number received by the firewall from the destination in a reverse communication; and the byte sequence number the firewall will provide to the source for the reverse communication; and
in the firewall, combining the second offset with a byte sequence number in a packet the firewall receives from the destination to determine a corresponding byte sequence number the firewall will provide to the source in place of the destination byte sequence number.

21. A firewall for use in a computer communication network to protect a secured host against attack from outside computers, the host and an outside computer communicating through the firewall via data packets including byte sequence numbers, one of them acting as a source and the other as a destination for a communication, the firewall comprising:
an offset processor generating an offset code which characterizes the byte sequence number received by the firewall from the source and corresponding byte sequence number the firewall provides to the destination for that communication; and
a combiner combining the offset with a source byte sequence number in a packet the firewall receives from the source to determine a corresponding destination byte sequence number the firewall will provides to the destination in place of the source byte sequence number.

22. The firewall of claim 21 wherein the offset processor combines an initial byte sequence number that the firewall provides to the destination an initial byte sequence number that the source provides to the firewall to produce the offset code.

23. The firewall of claim 22 wherein the offset processor performs a subtraction.

24. The firewall of claim 23 wherein the combiner performs an addition.

25. The firewall of claim 21 wherein the combiner performs an addition.

26. The firewall of claim 25 further comprising an additional offset processor and an additional combiner to permit simultaneous processing of a different source byte sequence number than the combiner.

27. The firewall of claim 26 wherein the additional combiner one of: substitutes for the combiner; and operates simultaneously with the combiner.

28. The firewall of claim 25 further comprising:
a second offset processor generating a second offset code which characterizes a byte sequence number received by the firewall from the destination in a reverse communication and a corresponding byte sequence number the firewall provides to the source for that reverse communication; and
a second combiner combining the second offset code with a byte sequence number in a packet the firewall receives from the destination to determine a corresponding byte sequence number the firewall will provide to the source in place of the destination byte sequence number.

29. The firewall of claim 24 further comprising an additional offset processor and an additional combiner to permit simultaneous processing of a different source byte sequence number than the combiner.

30. The firewall of claim 29 wherein the additional combiner one of: substitutes for the combiner; and operates simultaneously with the combiner.

31. The firewall of claim 24 further comprising:
a second offset processor generating a second offset code which characterizes a byte sequence number received by the firewall from the destination in a reverse communication and a corresponding byte sequence number the firewall provides to the source for that reverse communication; and
a second combiner combining the second offset code with a byte sequence number in a packet the firewall receives from the destination to determine a corresponding byte sequence number the firewall will provide to the source in place of the destination byte sequence number.

32. The firewall of claim 23 further comprising an additional offset processor and an additional combiner to permit simultaneous processing of a different source byte sequence number than the combiner.

33. The firewall of claim 32 wherein the additional combiner one of: substitutes for the combiner; and operates simultaneously with the combiner.

34. The firewall of claim 23 further comprising:
a second offset processor generating a second offset code which characterizes a byte sequence number received by the firewall from the destination in a reverse communication and a corresponding byte sequence number the firewall provides to the source for that reverse communication; and
a second combiner combining the second offset code with a byte sequence number in a packet the firewall receives from the destination to determine a corresponding byte sequence number the firewall will provide to the source in place of the destination byte sequence number.

35. The firewall of claim 22 further comprising an additional offset processor and an additional combiner to permit simultaneous processing of a different source byte sequence number than the combiner.

36. The firewall of claim 35 wherein the additional combiner one of: substitutes for the combiner; and operates simultaneously with the combiner.

37. The firewall of claim 22 further comprising:
a second offset processor generating a second offset code which characterizes a byte sequence number received by the firewall from the destination in a reverse communication and a corresponding byte sequence number the firewall provides to the source for that reverse communication; and
a second combiner combining the second offset code with a byte sequence number in a packet the firewall receives from the destination to determine a corresponding byte sequence number the firewall will provide to the source in place of the destination byte sequence number.

38. The firewall of claim 21 further comprising an additional offset processor and an additional combiner to permit simultaneous processing of a different source byte sequence number than the combiner.

39. The firewall of claim 38 wherein the additional combiner one of: substitutes for the combiner; and operates simultaneously with the combiner.

40. The firewall of claim 21 further comprising:
a second offset processor generating a second offset code which characterizes a byte sequence number received by the firewall from the destination in a reverse communication and a corresponding byte sequence number the firewall provides to the source for that reverse communication; and
a second combiner combining the second offset code with a byte sequence number in a packet the firewall receives from the destination to determine a corresponding byte sequence number the firewall will provide to the source in place of the destination byte sequence number.
